(19) United States
(12) Patent Application Publication
(10) Pub. No.: US 2014/0245675 A1
(43) Pub. Date: Sep. 4, 2014

(54) GLAZING ASSEMBLY WITH RADIANT ENERGY BARRIER

(71) Applicant: ASSOCIATED MATERIALS, LLC, Cuyahoga Falls, OH (US)

(72) Inventors: Anthony P. Bouquot, Hudson, OH (US); Robert A. Jablonski, Saint Paul, MN (US); Dan Green, Brecksville, OH (US); Steven R. Harp, Wyoming, MN (US); William J. Nowak, Sugarcreek, OH (US)

(73) Assignee: Associated Materials, LLC, Cuyahoga Falls, OH (US)

(21) Appl. No.: 13/782,050

(22) Filed: Mar. 1, 2013

(51) Int. Cl. E06B 3/54

(52) U.S. Cl. CPC E06B 3/5427
USPC 52/204.5

(57) ABSTRACT

A glazing assembly is disclosed. The glazing assembly includes a frame assembly including a frame member and a pane assembly secured within the frame assembly and defining a first plane. A radiant barrier member on the frame member is configured to reflect infrared radiation in a direction substantially perpendicular to the first plane.

Aspects of this invention relate generally to a glazing assembly, and, in particular, to a glazing assembly with a radiant energy barrier included as part of a frame member of the assembly.

### BACKGROUND

Energy conservation and efficiency have become critical design elements in all building products, and glazing assemblies, e.g., windows and doors, are no exception. With each new edition of the International Building Code, International Residential Code, and International Energy Conservation Code (collectively called the I-Codes), the energy efficiency requirements of glazing assemblies become more stringent.

Energy efficiency of glazing assemblies is measured in thermal conductivity, or U-value. The lower the U-value, the less heat and cold are transferred through the assembly, and the better insulator the glazing assembly is. U-value is the inverse of R-value, which is a common measure of energy efficiency of building insulation. The I-Codes specify maximum U-values for glazing assemblies, which vary for different areas of the country.

To meet the ever-decreasing U-value requirements, manufacturers have had to change the designs of their glazing assemblies. Double and triple pane insulated glass with high performance low emissivity coatings have become commonplace. In vinyl framing, metal reinforcements have been replaced by low conductivity materials like fiberglass and wood-plastic composites. Air-spaces or cavities inside the framing have been filled with insulation. All of these enhancements to the framing of glazing assemblies are focused exclusively on conductive and to a lesser degree, convective heat transfer.

It would be desirable to provide a glazing assembly that reduces the transfer of radiant energy through a glazing assembly, and reduces or overcomes some or all of the difficulties inherent in prior known devices. Particular advantages will be apparent to those skilled in the art, that is, those who are knowledgeable or experienced in this field of technology, in view of the following disclosure of the invention and detailed description of certain embodiments.

### SUMMARY

The principles of the invention may be used to provide a glazing assembly that reduces the transmission of radiant energy. In accordance with a first aspect, a glazing assembly includes a frame assembly with a frame member and a pane assembly secured within the frame assembly and defining a first plane. A radiant barrier member on the frame member is configured to reflect infrared radiation in a direction substantially perpendicular to the first plane.

In accordance with another aspect, a glazing assembly includes a frame assembly with a frame member defining a plurality of cavities. A pane assembly is secured within the frame assembly, and has a pane defining a first plane. Each of a plurality of radiant barrier members is received in one of the cavities and is configured to reflect infrared radiation in a direction substantially perpendicular to the first plane.

In accordance with a further aspect, a glazing assembly includes a frame assembly with a frame member defining a plurality of cavities. A pane assembly is secured within the frame assembly, and has a pane defining a first plane. Each of a plurality of radiant barrier assemblies is received in one of the cavities, and is configured to reflect infrared radiation in a direction substantially perpendicular to the first plane. At least one radiant barrier assembly includes an insert and a layer of reflective material on an interior surface of the insert. The radiant barrier assemblies may cooperate to provide a radiant barrier extending across substantially an entire width of the frame assembly.

By providing a glazing assembly with a radiant energy barrier included in the frame, the amount of radiant heat transferred through the framing of the assembly can be reduced, thus improving the overall energy efficiency of the glazing assembly, leading to reduced energy usage and decreased operating costs. These and additional features and advantages disclosed here will be further understood from the following detailed disclosure of certain embodiments.

### BRIEF DESCRIPTION OF THE DRAWINGS

FIG. 1 is a section view, shown partially broken away, of a fixed pane glazing assembly with a radiant barrier member positioned on an interior surface of a frame member of the glazing assembly.

FIG. 2 is a section view, shown partially broken away, of a double hung window with radiant barrier members positioned on interior surfaces of a fixed frame member and a movable sash of the window.

FIG. 3 is a section view, shown partially broken away, of a double hung glazing window with radiant barriers positioned within cavities of the frame member of the window.

FIG. 4 is a section view, shown partially broken away, of a fixed pane glazing assembly with a radiant barrier member positioned on an exterior surface of a frame member of the glazing assembly.

The figures referred to above are not drawn necessarily to scale, should be understood to provide a representation of particular embodiments of the invention, and are merely conceptual in nature and illustrative of the principles involved. Some features of the glazing assembly depicted in the drawings have been enlarged or distorted relative to others to facilitate explanation and understanding. The same reference numbers are used in the drawings for similar or identical components and features shown in various alternative embodiments. Glazing assemblies as disclosed herein would have configurations and components determined, in part, by the intended application and environment in which they are used.

### DETAILED DESCRIPTION OF CERTAIN PREFERRED EMBODIMENTS

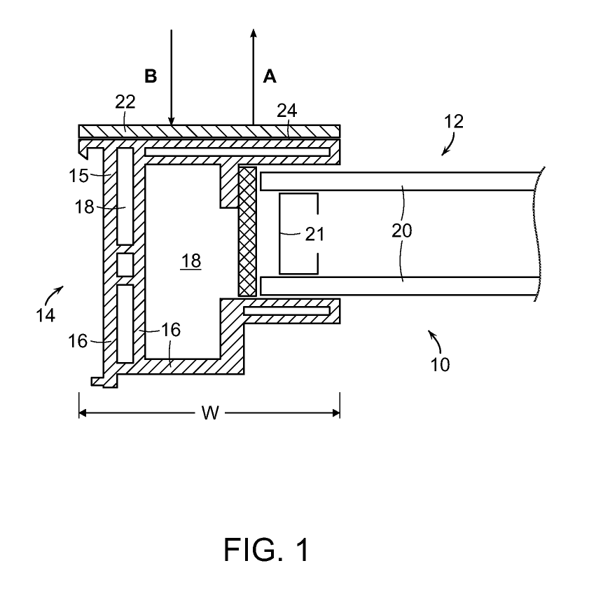

A glazing assembly 10 is depicted in FIG. 1 as including a pane assembly 12 seated and secured within a frame assembly 14. Glazing assemblies as discussed herein are intended to include various window types such as, but not limited to, fixed pane, double hung, single hung, sliders, casement and awning windows. Similarly, glazing assemblies as discussed herein are intended to include various door types such as, but not limited to, hinged, sliding, and rotating doors.

As seen here, looking down on glazing assembly 10 in section view, pane assembly 12, shown partially broken away, is mounted in a left frame member 15 of frame assembly 14. It is to be appreciated that frame assembly 14 includes a corresponding right frame member opposite left frame member 15, as well as top and bottom frame members extending between left frame member 15 and the right frame member, which are not shown here.

The term outwardly, outer, exterior, inwardly, inner, and interior refer generally to directions with respect to glazing assembly 10 as it is installed in a structure. Thus, in glazing assembly 10 as shown in FIG. 1, inwardly, inner, and interior are toward an interior of the structure and toward the top of the page in the direction of arrow A. Correspondingly, outwardly, outer, and exterior are toward an exterior of the structure and toward the bottom of the page in the direction of arrow B. Thus, a direction extending toward a top of glazing assembly 10 would extend away from the page toward the reader, and a direction extending toward a bottom of glazing assembly 10 would be away from the reader, into the page.

Left frame member 15 typically includes a plurality of frame elements 16 and a plurality of cavities 18 formed within and defined by frame elements 16. Frame elements 16 may be made of any of the commonly used materials in the industry including wood, plastics such as PVC, fiberglass, and wood-plastic composites, for example. In certain embodiments, frame elements 16 may have a central core formed of a first material and an exterior shell surrounding the core. Frame elements 16 could have a wood core with a plastic, e.g., PVC, exterior core. In other embodiments, a first exterior portion of frame assembly 14 that is exposed to an exterior of the structure in which glazing assembly 10 is installed has an outer surface formed of plastic (either solid plastic or a core covered with a plastic) or any other weather-resistant material, while a second interior portion of frame assembly 14 that is exposed to an interior of the structure is formed of wood. This allows the interior portion to be painted. Other suitable constructions of frame assembly 14 will become readily apparent to those skilled in the art, given the benefit of this disclosure.

Pane assembly 12 may include one or more glass panes 20. In the illustrated embodiment, pane assembly 12 is a double pane window with two panes 20 spaced from one another and mounted in frame assembly 14. A spacer 21 may be inserted between panes 20. It is to be appreciated that pane assembly 12 may have a single pane 20 or more than two panes 20.

A radiant barrier member 22 is positioned on an interior surface 24 of a frame element 16 of frame assembly 14. In the illustrated embodiment, radiant barrier member 22 is positioned on the innermost surface of frame assembly 14, seen here positioned inwardly of pane assembly 12.

Radiant barrier member 22 is designed to be highly reflective of radiant energy, or infrared radiation, in order to reduce radiant heat transfer, through frame assembly 14, thereby improving the overall efficiency of glazing assembly 10. In certain embodiments, radiant barrier member 22 is at least 75% reflective of radiant energy, or infrared radiation.

Radiant barrier member 22 extends along frame assembly 14 in a plane substantially parallel to a plane defined by a pane 20 of pane assembly 12. By extending in this direction, radiant barrier member 22 is configured to reflect radiant energy in a direction A that extends substantially perpendicular to the planes of the radiant barrier member 22 and pane 20, as seen in FIG. 1. Consequently radiant barrier member 22 reduces the transfer of radiant energy through frame assembly 14 in direction B. In this embodiment, radiant barrier member 22 extends across the entire width W of frame assembly 14, thereby providing a barrier to the transfer of radiant energy across the entire width W of frame assembly 14.

Radiant barrier member 22 may take the form of a metalized plastic sheet, such as MYLAR®, a polyester film provided by Dupont Tejjin Films. In other embodiments, radiant barrier member 22 may be a foil film. Radiant barrier member 22 could also be formed of metalized polyester, aluminum foil, metalized polyethylene, or any other film or coating with a reflectivity greater than about 75%.

It is to be appreciated that the right frame member, top frame member, and bottom frame member of frame assembly 14 will have a similar configuration and include a corresponding radiant barrier member 22.

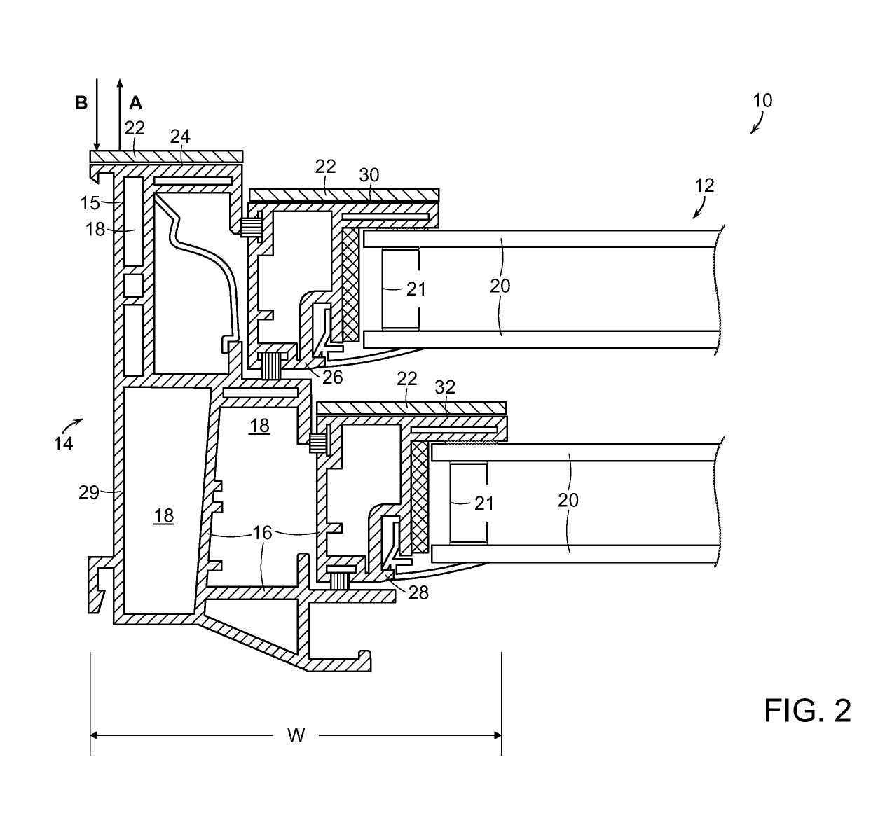

Another embodiment is illustrated in FIG. 2, in which glazing assembly 10 is a double hung window with an inner movable sash 26 having panes 20 secured therein and an outer movable sash 28 having panes 20 secured therein Inner movable sash 26 and outer movable sash 28 are engaged with and move vertically with respect to a fixed frame portion 29 of frame assembly 14. A radiant barrier member 22 is positioned on interior surface 24 of fixed frame portion 29 of frame assembly 14. Additional radiant barrier members 22 are positioned on an interior surface 30 of inner movable sash 26 and an interior surface 32 of outer movable sash 28. It is to be appreciated that in this embodiment, the combination of radiant barrier members 22 on frame assembly 14 and inner and outer movable sashes 26, 28 cooperate to provide a radiant barrier across substantially the entire width W of frame assembly 14.

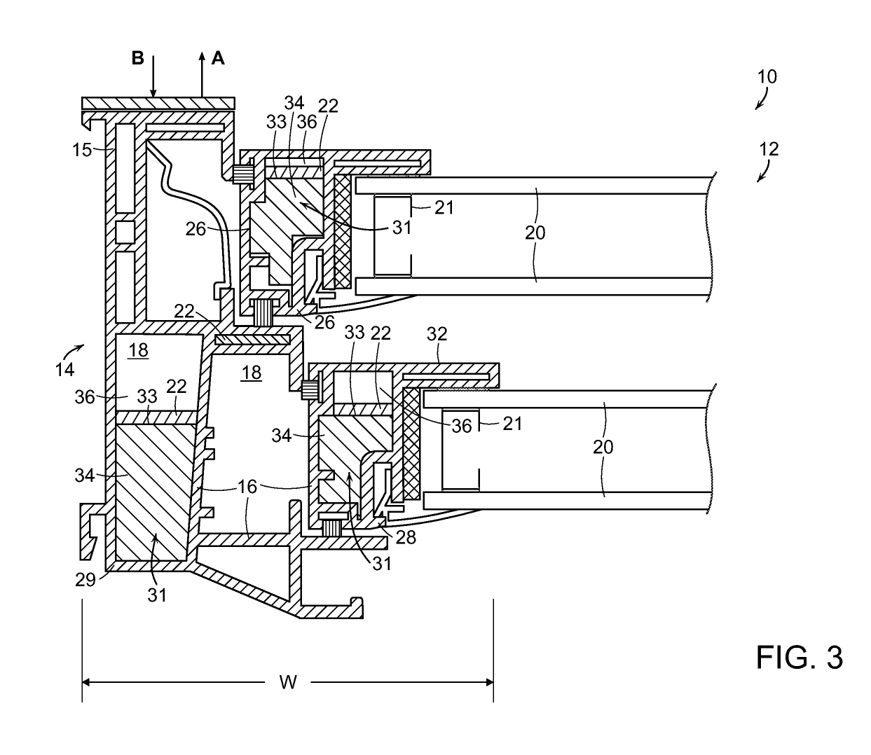

A further embodiment is illustrated in FIG. 3, in which frame assembly 13 includes a plurality of radiant barrier assemblies 31. Each radiant barrier assembly 31 is positioned within a cavity 18 of frame assembly 14. Radiant barrier assemblies 31 include a radiant barrier member 22 secured to a surface 33 of an insert 34. Radiant barrier assemblies 31 are inserted into a cavity 18 once they are assembled. As illustrated here, radiant barrier members 22 are secured to interior surfaces 33 of inserts 34.

In certain embodiments, radiant barrier member 22 may be laminated to insert 34. In other embodiments, radiant barrier member 22 may be secured to insert 34 with an adhesive, sprayed on, rolled on, or applied as a coating. Other means of securing radiant barrier member 22 to insert 34 will become readily apparent to those skilled in the art, given the benefit of this disclosure.

In certain embodiments, insert 34 may be formed of rigid foam board insulation. The foam board may be formed of expanded polystyrene, polyurethane, or polyisocyanurate, for example. In other embodiments, insert 34 may be a section of extruded vinyl, pultruded fiberglass, or other non-conductive materials. Other suitable materials for insert 34 will become readily apparent to those skilled in the art, given the benefit of this disclosure.

In the embodiment illustrated in FIG. 3 it can be seen that radiant barrier assemblies 31 may be sized such that they do not completely fill the cavity 18 into which they are received, leaving a gap 36 between an interior surface of radiant barrier member 22 and a corresponding frame element 16 in direction A. Providing gap 36 provides for easier insertion of radiant barrier assembly 31 into cavity 18.

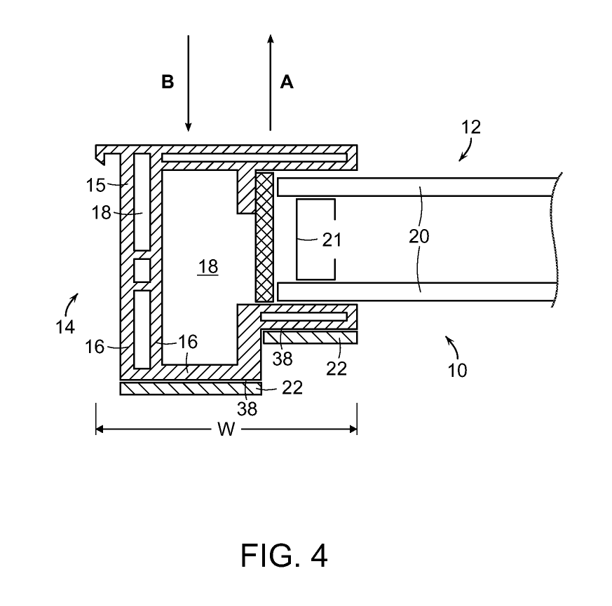

Another embodiment is illustrated in FIG. 4, in which a radiant barrier member 22 is positioned on an exterior surface 38 of a frame element 16 of frame assembly 14. In the illustrated embodiment, a pair of radiant barrier members 22 are positioned on outermost surfaces of frame assembly 14, seen here positioned outwardly of pane assembly 12.

Thus, while there have been shown, described, and pointed out fundamental novel features of various embodiments, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of individual elements, or more than one element, from one or more described embodiment to another are also fully intended and contemplated. It is the intention, therefore, to be limited only as indicated by the scope of the claims appended hereto.

1. A glazing assembly comprising:
a frame assembly including a frame member;
a pane assembly secured within the frame assembly and defining a first plane; and
a radiant barrier member on the frame member configured to reflect infrared radiation passing through the frame member in a direction substantially perpendicular to the first plane.

2. The glazing assembly of claim 1, wherein the radiant barrier member is disposed on an inwardly facing surface of the frame member.

3. The glazing assembly of claim 1, wherein the radiant barrier member is disposed on an innermost surface of the frame member.

4. The glazing assembly of claim 1, further comprising at east one additional radiant barrier member on the frame member.

5. The glazing assembly of claim 4, wherein the radiant barrier members cooperate to provide a radiant barrier extending across substantially an entire width of the frame assembly.

6. The glazing assembly of claim 1, wherein the radiant barrier member comprises a metalized plastic sheet.

7. The glazing assembly of claim 1, wherein the radiant barrier member comprises a sheet of polyester film.

8. The glazing assembly of claim 1, wherein the radiant barrier member comprises an insert and a layer of reflective material on an interior surface of the insert.

9. The glazing assembly of claim 8, wherein the radiant barrier member is positioned within a cavity formed in the frame assembly.

10. The glazing assembly of claim 8, wherein the insert is formed of one of a foam material, vinyl, and pultruded fiberglass.

11. The glazing assembly of claim 8, wherein the layer of reflective material is metalized plastic sheet.

12. The glazing assembly of claim 1, wherein the radiant barrier member has a radiant energy reflectivity of at least 75%.

13. The glazing assembly of claim 1, wherein the radiant barrier member defines a second plane that extends substantially parallel to the first plane.

14. The glazing assembly of claim 1, wherein the radiant barrier member extends across an entire width of the frame assembly.

15. A glazing assembly comprising:
a frame assembly including a frame member defining a plurality of cavities;
a pane assembly secured within the frame assembly, having a pane defining a first plane;
a plurality of radiant barrier members, each radiant barrier member received in one of the cavities and configured to reflect infrared radiation in a direction substantially perpendicular to the first plane.

16. The glazing assembly of claim 15, wherein at least one radiant barrier member comprises:
an insert, and
layer of reflective material on an interior surface of the insert.

17. The glazing assembly of claim 16, wherein each insert is formed of one of a foam material, vinyl, and pultruded fiberglass.

18. The glazing assembly of claim 16, wherein the layer of reflective material is a metalized plastic sheet.

19. The glazing assembly of claim 15, wherein the radiant barrier members cooperate to provide a radiant barrier extending across substantially an entire width of the frame member.

20. A glazing assembly comprising:
a frame assembly including a frame member defining a plurality of cavities;
a pane assembly secured within the frame assembly, having a pane defining a first plane;
a plurality of radiant barrier assemblies, each radiant barrier assembly received in one of the cavities, configured to reflect infrared radiation in a direction substantially perpendicular to the first plane, at least one radiant barrier assembly comprising:
an insert; and
a layer of reflective material on an interior surface of the insert;
wherein the radiant barrier assemblies cooperate to provide a radiant barrier extending across substantially an entire width of the frame assembly.
